(19) United States
(12) Patent Application Publication
(10) Pub. No.: US 2026/0353429 A1
(43) Pub. Date: Nov. 5, 2026

(54) SYSTEM AND METHOD FOR COLLABORATIVE UPLINK TRAFFIC CONTROL LOOPS OF RAN AND OPERATIONAL TECHNOLOGY APPLICATIONS IN ENTERPRISE DEPLOYMENTS

(71) Applicant: Nokia Solutions and Networks Oy, Espoo (FI)

(72) Inventors: Edward GRINSHPUN, Murray Hill, NJ (US); NAKJUNG CHOI, Murray Hill, NJ (US); Catello DI MARTINO, Sao Paulo (BR); Alberto RODRIGUES, Sao Paulo (BR); Jinfeng DU, Murray Hill, NJ (US); Saeed Reza KHOSRAVIRAD, Murray Hill, NJ (US)

(21) Appl. No.: 19/644,349

(22) Filed: Apr. 10, 2026

Related U.S. Application Data
(60) Provisional application No. 63/787,291, filed on Apr. 11, 2025.

(51) Int. Cl. H04W 72/542; H04L 43/0876; H04W 28/24; H04W 60/04; H04W 64/00

(52) U.S. Cl. CPC H04W 72/542; H04L 43/0876; H04W 28/24; H04W 60/04; H04W 64/00

(57) ABSTRACT

A network node may obtain SLA information associated with at least one wireless communication channel, location information associated with at least one network device, and network device-measured network performance information associated with the at least one wireless communication channel, obtain network resource information and network scheduling information associated with the at least one wireless communication channel, predict network performance information associated with the at least one wireless communication channel for a future time period based on the location information, the network device-measured network performance information, the network resource information, and the network scheduling information, predict SLA compliance information for the future time period based on the SLA information and the predicted network performance information, and adjust network resource allocation for the at least one network device based on the predicted SLA compliance information.

### RELATED FIELD

Various example embodiments relate to methods, apparatuses, systems, and/or non-transitory computer readable media for performing collaborative uplink (UL) traffic control loops of a radio access network (RAN) node and operational technology (OT) application in enterprise deployments.

### BACKGROUND

A 5^{th} generation mobile network (5G) standard, referred to as 5G New Radio (NR), is being developed to provide higher capacity, higher reliability, and lower latency communications than the 4G long term evolution (LTE) standard.

With the deployment of 5G networks and other high-speed networks, there has been increased proliferation of network-enabled devices and/or applications, such as autonomous vehicles, robots, Internet of Things (IoT) devices, industrial sensors, network-enabled medical devices, etc., which have been adapted to take advantage of the higher capacity, higher reliability, and lower latency communications service.

One proposed implementation of 5G network capabilities is related to the field of wirelessly controlled OT machinery, cloud robotics, and/or other industrial wirelessly controlled devices, where the controller and/or control system of the OT machinery, etc., is located in a cloud network (e.g., a private network, a Wide Area Network (WAN), a core network, the Internet, etc.) and provides control instructions to the wirelessly controlled device, e.g., an autonomous mining drill, an autonomous ground vehicle (AGV), a robot, actuators, an unmanned aerial vehicle (UAV), sensors, etc.

### SUMMARY

At least one example embodiment is directed to a network node.

In at least one example embodiment, the network node may include memory storing computer readable instructions, and processing circuitry configured to execute the computer readable instructions to cause the network node to, obtain service level agreement (SLA) information associated with at least one wireless communication channel, location information associated with at least one network device, and network device-measured network performance information associated with the at least one wireless communication channel, obtain network resource information and network scheduling information associated with the at least one wireless communication channel, predict network performance information associated with the at least one wireless communication channel for a future time period based on the location information, the network device-measured network performance information, the network resource information, and the network scheduling information, predict SLA compliance information for the future time period based on the SLA information associated with the at least one wireless communication channel and the predicted network performance information associated with the at least one wireless communication channel, and adjust network resource allocation for the at least one network device based on the predicted SLA compliance information.

Some example embodiments provide that the network performance information includes at least one of: uplink (UL) cell congestion information, UL network device channel metric information, UL latency information, UL throughput information, or any combinations thereof.

Some example embodiments provide that the network device-measured network performance information includes at least one of: current network resource allocation information associated with the at least one network device, downlink (DL) channel quality measurement information associated with the at least one network device, UL queuing latency information associated with the at least one network device, or any combinations thereof.

Some example embodiments provide that the network node is further caused to adjust network resource allocation for the at least one network device by, adjust network scheduling for the at least one network device for the future time period based on the predicted SLA compliance information, and transmit the adjusted network resource allocation and the adjusted network scheduling to a radio access network (RAN) node serving the at least one network device.

Some example embodiments provide that the network node is further caused to, transmit the predicted network performance information and the predicted SLA compliance information to a network controller of the at least one network device, the transmitting enabling the network controller to, modify operation of the at least one network device based on the predicted network performance information, the predicted SLA compliance information, and a SLA compliance threshold.

Some example embodiments provide that the network node is further caused to, obtain an identification pulse profile (IPP) associated with the at least one wireless communication channel from a network controller of the at least one network device, register the IPP, the registering including associating the IPP with the at least one network device, identify the network resource information and the network scheduling information associated with the at least one wireless communication channel from network data received by the network node based on the registered IPP, predict the network performance information based on the identified network resource information and the identified network scheduling information, and determine whether a SLA violation has occurred based on the SLA information and the predicted network performance information.

Some example embodiments provide that the network node is further caused to, obtain predicted UL communication patterns associated with the at least one network device from the network controller of the at least one network device, and generate a network map corresponding to a target time period based on the network performance information, the network device-measured network performance information, the location information associated with the at least one network device, and the predicted UL communication patterns associated with the at least one network device.

Some example embodiments provide that the network map indicates at least one of: a location of the at least one network device, serving cell congestion information, UL channel performance metric information, probability of the at least one network device being served by a particular serving cell, or any combinations thereof.

Some example embodiments provide that the network map further includes a plurality of pixels, each pixel corresponding to a three-dimensional (3D) geographic area, a size of each pixel of the network map is based on a sensitivity of available location sensors corresponding to the 3D geographic area, and each pixel includes information indicating at least one of: serving cell congestion information corresponding to the 3D geographic area, UL channel performance metric information corresponding to the 3D geographic area, probability of the at least one network device being served by a particular serving cell corresponding to the 3D geographic area, or any combinations thereof.

Some example embodiments provide that the at least one wireless communication channel is at least one RAN Data Radio Bearer configured to carry UL traffic associated with at least one application executed by the at least one network device.

Some example embodiments provide that the location information associated with at least one network device includes current location information associated with the at least one network device and future location information associated with the at least one network device predicted by a network controller of the at least one network device.

Some example embodiments provide that the network node is at least one of: a near-real time radio access network (RAN) intelligent controller (RIC), a non-real time RIC, a virtual RAN, or a cloud RAN, or any combinations thereof.

At least one example embodiment is directed to a network node.

In at least one example embodiment the network node may include memory storing computer readable instructions, and processing circuitry configured to execute the computer readable instructions to cause the network node to, obtain current location information and network device-measured network performance information from at least one network device, predict future location information for the at least one network device for a future time period based on operation control of the at least one network device for the future time period, predict future uplink (UL) network traffic information associated with at least one wireless communication channel for the future time period based on the predicted future location information and current UL network traffic information associated with the at least one wireless communication channel, transmit service level agreement (SLA) information associated with the at least one wireless communication channel, the current location information, the predicted future location information, the current UL network traffic information, the predicted future UL network traffic information, and the network device-measured network performance information associated with the at least one wireless communication channel, obtain predicted SLA compliance information and predicted network performance information associated with the at least one network device from a network control node, and modify the operation control of the at least one network device for the future time period based on the predicted SLA compliance information and a SLA compliance threshold.

Some example embodiments provide that the network device-measured network performance information includes at least one of: current network resource allocation information associated with the at least one wireless communication channel, downlink (DL) channel quality measurement information associated with the at least one network device, UL queuing latency information associated with the at least one network device, or any combinations thereof.

Some example embodiments provide that the network node is further caused to, obtain the SLA information associated with the at least one wireless communication channel, define a plurality of identification pulse profiles (IPP) for a plurality of wireless communication channels, the plurality of wireless communication channels including the at least one wireless communication channel, transmit the SLA information and the IPP for the at least one wireless communication channel to the network operational control node, receive the predicted SLA compliance information from the network operational control node in response to the SLA information, the predicted SLA compliance information including at least one predicted SLA violation notification, and modify the operation control of the at least one network device in response to the at least one predicted SLA violation notification exceeding the SLA compliance threshold.

Some example embodiments provide that the network node is further caused to, predict UL communication patterns associated with the at least one network device based on telemetry information associated with the at least one network device and application session status associated with the at least one network device, transmit the predicted UL communication patterns to the network operational control node, and transmit the predicted future location information for the at least one network device to the network operational control node, the predicted future location information including a plurality of future location coordinates of the at least one network device, each of the plurality of future location coordinates associated with a future timestamp.

Some example embodiments provide that the network node is further caused to, transmit at least one identification pulse profile (IPP) associated with the at least one wireless communication channel to the at least one network device, the IPP uniquely identifying the at least one wireless communication channel, periodically receive an identification pulse from the at least one network device, the identification pulse corresponding to the IPP, and transmit a notification to the at least one network device in response to receiving the predicted SLA compliance information from the network operational control node, the notification instructing the at least one network device to discontinue transmission of the identification pulse.

Some example embodiments provide that the identification pulse is a unique data transmission pattern assigned to the at least one wireless communication channel.

Some example embodiments provide that the network node is further caused to, periodically receive the current location information and the network device-measured network performance information from the at least one network device, transmit the received current location information and the network device-measured network performance information to the network operational control node, and receive the predicted SLA compliance information and the predicted network performance information from the network operational control node in response to the transmission.

At least one example embodiment is directed to a network device.

In at least one example embodiment the network device may include memory storing computer readable instructions, and processing circuitry configured to execute the computer readable instructions to cause the network device to, receive at least one identification pulse profile (IPP) associated with at least one wireless communication channel from a network controller associated with the network device, the IPP identifying the at least one wireless communication channel using a unique data transmission pattern assigned to the at least one wireless communication channel, periodically transmit an identification pulse to the network controller, the identification pulse corresponding to the IPP, periodically transmit current location information and network device-measured network performance information associated with the at least one wireless communication channel to the network controller, and receive adjusted network resource allocation from a network node and modified operation control instructions from the network controller in response to the transmitted current location information and the transmitted network device-measured network performance information.

At least one example embodiment is directed to a network node.

In at least one example embodiment the network node may include means for obtaining service level agreement (SLA) information associated with at least one wireless communication channel, location information associated with at least one network device, and network device-measured network performance information associated with the at least one wireless communication channel, obtaining network resource information and network scheduling information associated with the at least one wireless communication channel, predicting network performance information associated with the at least one wireless communication channel for a future time period based on the location information, the network device-measured network performance information, the network resource information, and the network scheduling information, predicting SLA compliance information for the future time period based on the SLA information associated with the at least one wireless communication channel and the predicted network performance information associated with the at least one wireless communication channel, and adjusting network resource allocation for the at least one network device based on the predicted SLA compliance information.

Some example embodiments provide that the network performance information includes at least one of: uplink (UL) cell congestion information, UL network device channel metric information, UL latency information, UL throughput information, or any combinations thereof.

Some example embodiments provide that the network device-measured network performance information includes at least one of: current network resource allocation information associated with the at least one network device, downlink (DL) channel quality measurement information associated with the at least one network device, UL queuing latency information associated with the at least one network device, or any combinations thereof.

Some example embodiments provide that the network node further includes means for adjusting network resource allocation for the at least one network device by, adjusting network scheduling for the at least one network device for the future time period based on the predicted SLA compliance information, and transmitting the adjusted network resource allocation and the adjusted network scheduling to a radio access network (RAN) node serving the at least one network device.

Some example embodiments provide that the network node further includes means for, transmitting the predicted network performance information and the predicted SLA compliance information to a network controller of the at least one network device, the transmitting enabling the network controller to, modify operation of the at least one network device based on the predicted network performance information, the predicted SLA compliance information, and a SLA compliance threshold.

Some example embodiments provide that the network node further includes means for, obtaining an identification pulse profile (IPP) associated with the at least one wireless communication channel from a network controller of the at least one network device, registering the IPP, the registering including associating the IPP with the at least one network device, identifying the network resource information and the network scheduling information associated with the at least one wireless communication channel from network data received by the network node based on the registered IPP, predicting the network performance information based on the identified network resource information and the identified network scheduling information, and determining whether a SLA violation has occurred based on the SLA information and the predicted network performance information.

Some example embodiments provide that the network node further includes means for, obtaining predicted UL communication patterns associated with the at least one network device from the network controller of the at least one network device, and generating a network map corresponding to a target time period based on the network performance information, the network device-measured network performance information, the location information associated with the at least one network device, and the predicted UL communication patterns associated with the at least one network device.

Some example embodiments provide that the network map indicates at least one of: a location of the at least one network device, serving cell congestion information, UL channel performance metric information, probability of the at least one network device being served by a particular serving cell, or any combinations thereof.

Some example embodiments provide that the network map further includes a plurality of pixels, each pixel corresponding to a three-dimensional (3D) geographic area, a size of each pixel of the network map is based on a sensitivity of available location sensors corresponding to the 3D geographic area, and each pixel includes information indicating at least one of: serving cell congestion information corresponding to the 3D geographic area, UL channel performance metric information corresponding to the 3D geographic area, probability of the at least one network device being served by a particular serving cell corresponding to the 3D geographic area, or any combinations thereof.

Some example embodiments provide that the at least one wireless communication channel is at least one RAN Data Radio Bearer configured to carry UL traffic associated with at least one application executed by the at least one network device.

Some example embodiments provide that the location information associated with at least one network device includes current location information associated with the at least one network device and future location information associated with the at least one network device predicted by a network controller of the at least one network device.

Some example embodiments provide that the network node is at least one of: a near-real time radio access network (RAN) intelligent controller (RIC), a non-real time RIC, a virtual RAN, or a cloud RAN, or any combinations thereof.

At least one example embodiment is directed to a network node.

In at least one example embodiment the network node may include means for obtaining current location information and network device-measured network performance information from at least one network device, predicting future location information for the at least one network device for a future time period based on operation control of the at least one network device for the future time period, predicting future uplink (UL) network traffic information associated with at least one wireless communication channel for the future time period based on the predicted future location information and current UL network traffic information associated with the at least one wireless communication channel, transmitting service level agreement (SLA) information associated with the at least one wireless communication channel, the current location information, the predicted future location information, the current UL network traffic information, the predicted future UL network traffic information, and the network device-measured network performance information associated with the at least one wireless communication channel, obtaining predicted SLA compliance information and predicted network performance information associated with the at least one network device from a network control node, and modifying the operation control of the at least one network device for the future time period based on the predicted SLA compliance information and a SLA compliance threshold.

Some example embodiments provide that the network device-measured network performance information includes at least one of: current network resource allocation information associated with the at least one wireless communication channel, downlink (DL) channel quality measurement information associated with the at least one network device, UL queuing latency information associated with the at least one network device, or any combinations thereof.

Some example embodiments provide that the network node further includes means for, obtaining the SLA information associated with the at least one wireless communication channel, define a plurality of identification pulse profiles (IPP) for a plurality of wireless communication channels, the plurality of wireless communication channels including the at least one wireless communication channel, transmitting the SLA information and the IPP for the at least one wireless communication channel to the network operational control node, receiving the predicted SLA compliance information from the network operational control node in response to the SLA information, the predicted SLA compliance information including at least one predicted SLA violation notification, and modifying the operation control of the at least one network device in response to the at least one predicted SLA violation notification exceeding the SLA compliance threshold.

Some example embodiments provide that the network node further includes means for, predicting UL communication patterns associated with the at least one network device based on telemetry information associated with the at least one network device and application session status associated with the at least one network device, transmitting the predicted UL communication patterns to the network operational control node, and transmitting the predicted future location information for the at least one network device to the network operational control node, the predicted future location information including a plurality of future location coordinates of the at least one network device, each of the plurality of future location coordinates associated with a future timestamp.

Some example embodiments provide that the network node further includes means for, transmitting at least one identification pulse profile (IPP) associated with the at least one wireless communication channel to the at least one network device, the IPP uniquely identifying the at least one wireless communication channel, periodically receiving an identification pulse from the at least one network device, the identification pulse corresponding to the IPP, and transmitting a notification to the at least one network device in response to receiving the predicted SLA compliance information from the network operational control node, the notification instructing the at least one network device to discontinue transmission of the identification pulse.

Some example embodiments provide that the identification pulse is a unique data transmission pattern assigned to the at least one wireless communication channel.

Some example embodiments provide that the network node further includes means for, periodically receiving the current location information and the network device-measured network performance information from the at least one network device, transmitting the received current location information and the network device-measured network performance information to the network operational control node, and receiving the predicted SLA compliance information and the predicted network performance information from the network operational control node in response to the transmission.

At least one example embodiment is directed to a network device.

In at least one example embodiment the network device may means for, receiving at least one identification pulse profile (IPP) associated with at least one wireless communication channel from a network controller associated with the network device, the IPP identifying the at least one wireless communication channel using a unique data transmission pattern assigned to the at least one wireless communication channel, periodically transmitting an identification pulse to the network controller, the identification pulse corresponding to the IPP, periodically transmitting current location information and network device-measured network performance information associated with the at least one wireless communication channel to the network controller, and receiving adjusted network resource allocation from a network node and modified operation control instructions from the network controller in response to the transmitted current location information and the transmitted network device-measured network performance information.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates an example wireless system according to at least one example embodiment;

FIG. 2 illustrates a block diagram of an example network node and/or network device according to at least one example embodiment;

FIG. 3 is a transmission diagram illustrating an example method for performing service level agreement (SLA) registration according to at least one example embodiment;

FIG. 4 is a transmission diagram illustrating an example method for generating a network map according to at least one example embodiment;

FIG. 5 illustrates an example network map according to at least one example embodiment; and

FIG. 6 is a transmission diagram illustrating an example method for performing predictive SLA verification and operational control of a network device according to at least one example embodiment.

### DETAILED DESCRIPTION

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

Various example embodiments will now be described more fully with reference to the accompanying drawings in which some example embodiments are illustrated.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments configured forth herein.

It will be understood that, although the terms first, second, and so on may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent”).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures illustrated in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be illustrated in block diagrams in order not to obscure the example embodiments in unnecessary detail. In other instances, well-known processes, structures and techniques may be illustrated without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, and/or a subprogram. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, and/or hardware description languages, in combination with hardware (e.g., software executed by hardware). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a service, a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, and/or data, may be passed, forwarded, or transmitted via any suitable means including memory sharing, message passing, token passing, and/or network transmission.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, or an application-specific integrated circuit (ASIC).

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the 5G wireless communication standard for the sake of clarity and convenience, the example embodiments are not limited thereto, and one of ordinary skill in the art would recognize the example embodiments may be modified and/or adapted to use other wireless communication standards, such as the 4G standard, a Wi-Fi standard, a future 6G standard, a future 7G standard, etc.

Various example embodiments are directed towards reliably and/or optimally performing collaborative UL traffic control loops between a RAN node and OT applications in enterprise deployments. An OT control system refers to a control system for wirelessly controlled OT machinery and/or OT equipment, or in other words, a wirelessly controlled device (WCD). Examples of the WCD may include a robot, an AGV, a UAV, a driller, a sensor, a video camera, etc., but are not limited thereto. A controller of the WCD is located on a network (e.g., a private network, a private wireless network, a cloud network, etc.), such as at an edge network node, at a core network node, etc., of the network, and transmits instructions to the WCD and/or receives feedback data from the WCD (e.g., sensor data, video data, etc.) over the network. In contrast to direct control systems where the controller is “onboard” the controlled device, physically connected to the controlled device, and/or within direct communication range of the controlled device, the WCD is controlled by a controller that is connected to the WCD over at least one network. Because the controller is transmitting and/or receiving data to/from the WCD over a network, the service level agreement (SLA) requirements (e.g., quality of service (QoS) requirements, etc.) such as latency, throughput, jitter, reliability (e.g., packet loss), survival time, and/or service availability, for the data communications may be high.

Further, the WCD and its respective network controller may execute one or more applications (e.g., OT applications, OT services, etc.) related to the control and/or operation of the WCD, such as an application directed towards controlling the driving of an autonomous vehicle, an application directed towards capturing video from a camera installed on the autonomous vehicle, an application directed towards a sensor installed on the autonomous vehicle, etc. Each of the applications may have of different criticality levels and/or priority levels, such as Mission Critical (MC) applications, Business Critical (BC) applications, and/or non-MC application applications, and each of the different criticality levels may have different service level agreement (SLA) requirements related to corresponding to them.

For example, Enterprise vertical industries, like the mining industry, etc., may utilize Private Wireless Access (PWA) networks to operate a variety of MC, BC, and non-MC/BC applications. For example, an Enterprise vertical industry may desire and/or require the remote control operations of a large number of mobile and stationary machines, and may require uninterrupted operation of each of the machines, which in turn may require tight SLA requirements on the connecting RAN node to carry in the uplink direction a large number of individual MC/BC application flows with different SLA requirements, e.g., different low latency and/or variable high bitrate requirements, etc., as well as requiring the handling and/or servicing of other (non-MC) application flows.

Any SLA violations may lead to service interruptions (e.g., downtime) of BC and/or MC applications. Prolonged service interruptions of BC and/or MC networked applications may require stoppage of the autonomous business operation (e.g., stoppage of the WCD, etc.) until a human crew is dispatched and resolves the issue. Such stoppage is typically initiated to reduce and/or prevent human injuries and even loss of lives, reduce and/or prevent damage to the WCD and/or the environment, and may lead to significant loss of business revenue (potentially up to millions of dollars). In the mining industry use case, MC telemetry data generated by a variety of sensors and video cameras installed on the WCD may be and/or must be continuously uploaded to mission control (e.g., an OT control network node, etc.) from autonomously operating drillers, shovels, trucks, and dozers, etc.

For example, Table 1 illustrates examples of wireless network requirements for mining-industry MC, BC, and non-MC applications.

TABLE 1

| | Typical | | Latency |
|---|---|---|---|
| Use case/application | Criticality | Throughput | (max) |
| Driver fatigue monitor | non MC | <256 kbps | 500 ms |
| Non-critical broadband comm | non MC | >2 Mbps | 100 ms |
| on mining site | | | |
| Mobile broadband to adjacent | non MC | >10 Mbps | 100 ms |
| mining communities | | | |
| Personal health monitoring | non MC | <64 kbps | 60 s |
| Smart metering | non MC | <64 kbps | NA |
| Belt conveyor monitoring | BC | <64 kbps | 500 ms |
| Non-critical IoT sensors comms | non MC | <64 kbps | 500 ms |
| Asset lifecycle optimization & | non MC | <64 kbps | 500 ms |
| maintenance (Analytics) | | | |
| Water quality monitoring | non MC | <64 kbps | NA |
| Access control systems | non MC | <64 kbps | 100 ms |
| Remote vehicle control with | MC | >3 Mbps | 20 ms |
| CCTV | | | |
| Mission Critical PTT/PTV | MC | <64 kbps | 300 ms |
| | | (voice) | (voice) |
| | | >512 kbps | 100 ms |
| | | (video) | (video) |
| Tailing dams monitoring with | MC | >512 kbps | 100 ms |
| CCTV | | | |
| Fleet Management/Dispatch | MC | <128 kbps | 20 ms |
| systems | | | |
| Personal location with wearables, | MC | <64 kbps | 30 s |
| GIS | | | |
| CCTV/HD with Video Analytics | BC | >5 Mbps | 100 ms |
| Critical IoT sensors comms | MC | <64 kbps | 50 ms |
| Drone systems inspection with | BC | >512 kbps | 20 ms |
| streaming | | | |
| Autonomous Haulage System | MC | >512 kbps | 20 ms |
| (AHS) | | | |
| Autonomous Drilling System | MC | >6 Mbps | 20 ms |
| (ADS) | | | |
| Autonomous Crane System | MC | >6 Mbps | 20 ms |
| (port) | | | |
| Electrical substations & | BC | >128 kbps | 20 ms |
| generator system monitor | | | |
| (Remote automation) | | | |
| AR/VR for maintenance and | non MC | >5 Mbps | 10 ms |
| training 4K video | BC | >20 Mbps | 100 ms |
| Proximity/Collision warning | MC | >128 kbps | 5 ms |
| systems (V2X via cellular | | | |
| ntw) | | | |
| Automation systems based | BC | >128 kbps | 2 ms |
| on Time sensitivity network | | | |
| (critical SCADA systems) | | | |
| Collaborative robotics | BC | >128 kbps | 5 ms |

However, high SLA requirements may cause extremely high resource strains on wireless communications systems. While there have been efforts to improve the quality of experience of OT applications, etc., by detecting network impairments and/or performance degradation on the end user's side (e.g., the WCD side and/or the UE side, etc.) and adapting their network traffic streams in response to the network limitations (e.g., reducing the frame rate and/or video resolution of video streams transmitted by the end user application, reducing the speed of an autonomously vehicle, stopping an autonomous vehicle, etc.), these solutions are not ideal because they are reactive and not proactive, and only adapt after a degradation of performance has been observed. For some wireless control systems (e.g., OT systems), such as industrial wireless control, autonomous vehicle guidance, etc., such reactive corrective measures may be insufficient and may lead to increased performance dysfunctions, security concerns, and/or safety threats, such as an autonomous vehicle crashing, an industrial robot harming a human operator, etc., due to lack of control from the network controller.

For example, in the mining industry use case, multiple autonomous trucks may be served by the same cell (e.g., the same RAN node) and each of the autonomous trucks may send large volumes of uplink LiDAR/camera data at a constant high resolution. While all of the autonomous trucks are located and/or travel in cell service areas with good wireless channel conditions, the SLAs for each of the OT applications corresponding to the autonomous trucks are maintained. However, one or more trucks may experience wireless channel quality degradation, e.g., due to entering an area with low channel quality, or due to temporary shadowing and/or signal blocking by other machines, etc. For an autonomous truck with degraded wireless channel quality to maintain a SLA related to data throughput, the RAN node would need to start allocating a larger amount of wireless resources (e.g., PRBs, etc.) to compensate for the reduced data rate of the modulation and coding schemes imposed by the degraded wireless channel. If these extra wireless resources are not available because, for example, other MC/BC application sessions are operating which are served by the same cell, then throughput, latency, and/or packet-loss SLA violations will follow for the autonomous truck with degraded wireless channel quality.

A prolonged SLA violation for even a single autonomous truck may lead mission control to stop all autonomous machinery in the area for safety reasons, and may require human crews to be dispatched for recovery operations. Additionally, a typical operational response for autonomously guided vehicles to degraded network throughput and/or latency may be a reduction of the vehicle speed. Such slowing down of the truck with poor channel conditions may have the adverse effect of keeping the truck in the poor channel area for a longer time, therefore further prolonging the duration of the SLA violation.

Additionally, some reactive remedies to the network limitations (e.g., network congestion, etc.) may not solve and/or may exacerbate the performance degradation of the WCDs. For example, an autonomous vehicle may transmit large volumes of UL data, such as MC and/or BC LiDAR and/or camera data, and the autonomous vehicle may travel into a geographic area with poor wireless channel quality and/or may temporarily experience wireless channel quality degradation which prohibits the autonomous vehicle from transmitting the large volume of UL data in accordance with its SLA requirements, which results in an SLA violation. To remedy potential safety issues, the network controller may instruct the autonomous vehicle to slow down or stop moving in order to avoid a collision, but by slowing down or stopping the autonomous vehicle in the geographic area with poor wireless channel quality, the network controller may prolong the SLA violation. After the number of SLA violations and/or the length of an ongoing SLA violation exceeds a SLA threshold, the network controller may shut down the autonomous vehicle and require time consuming and/or expensive human intervention to restart the autonomous vehicle and drive the autonomous vehicle to a location with sufficient wireless channel quality to meet the SLA requirements of the autonomous vehicle, etc. A common approach to remedy this situation is to greatly increase the amount of wireless resources provisioned to each WCD, or in other words to significantly overprovisioning wireless resources for each WCD based on a worst-case scenario basis, but this approach may leave the network resources of the PWA heavily underutilized most of the time, e.g., during good wireless conditions, and may add significant additional expense to the PWA cost for the Enterprise due to the overprovisioning of wireless network equipment (e.g., RAN nodes, base stations, repeaters, etc.).

Accordingly, an approach is desired to provide an interface between OT applications, e.g., WCDs, etc., and the network which enables for improved and/or optimized network procedures, such as improved network resource allocation, improved network scheduling, and/or improved OT application control, based on the current application goals of the WCD, current network conditions, and predicted future network conditions. More specifically, one or more example embodiments are directed to systems, apparatuses, methods, and/or non-transitory computer readable media for providing mutual predictive awareness between an OT control system and a RAN node at a granularity needed for enabling improved reliability of OT operations with UL SLA guarantees for MC and/or BC application flows via improved and/or more efficient levels of collaboration between the respective OT and RAN resource allocation control loops by generating OT control based on predicted (e.g., future) network state information that is localized for and/or corresponds to the current and future geographical vicinity of a respective OT machine. One or more example embodiments enable the RAN node and the OT controller to determine improved and/or optimal dynamic network resource allocation and/or scheduling (such as spectral resource allocation across individual Data Radio Bearers (DRBs), traffic steering, load balancing, beam forming, etc.), as well as improved and/or optimal OT control instructions, based on the predicted OT machine geo-locations and the dynamic SLAs of the OT control application data traffic flows. By providing mutual predictive awareness with sufficient flow/geo-location granularity and time frequency, one or more of the example embodiments may provide one or more of the following benefits and/or advantages: improved RAN network coverage planning and/or more efficient dynamic Radio Frequency coverage changes based upon OT needs and available RAN spectral resources; improved trajectory planning for OT mobile equipment (e.g. autonomous trucks, dozers, etc.); improved and/or optimized “application level spectral efficiency” (e.g., more SLA-complaint uplink data flows using same amount of spectral resources) for Uplink resource scheduling by coordinating Uplink PRB allocation across UEs with queueing/scheduling at CDM Endpoints; reduced downtime for OT operations by reducing RAN SLR violations. The latter is done by making operational choices for OT machines with knowledge of predicted RAN operational performance in the respective geo-location area, and/or making RAN resource allocation choices to meet requirements of predicted geolocations and network performance needs of OT equipment.

For example, RAN SLA violations may occur due to UL RAN congestion as a result of too many autonomous trucks with, e.g., high volume LiDAR UL traffic moving to the coverage area of a cell already serving one or more drillers with high volume UL video from multiple cameras, etc. Rather than waiting for this scenario to occur (which may cause a SLA violation for all of the machines, resulting in operation stop if not resolved quickly), one or more of the example embodiments would allow for the OT control and the RAN to collaborate by, e.g., first-allowing the OT control to proactively and/or dynamically manage the trajectories and/or speeds of the trucks to ensure that only a desired and/or predetermined number of trucks be located in that cell coverage area simultaneously, which would reduce and/or prevent RAN congestion; and second—the RAN may use adaptive UL transmission directivity patterns to create peak gains for the direction of the transmitting UEs (e.g., the trucks and drillers) and may create nulls for the direction of interfering neighbor cells, thus increasing the UL throughput to allow for more trucks in the cell coverage area.

While the example embodiments are discussed in connection with an autonomous ground vehicle, the example embodiments are not limited thereto, and for example, one or more aspects of the example embodiments may be applied to controlling robot movement and/or robot traffic in a warehouse facility, controlling actuators and/or other mechanically operated devices, controlling sensors and/or security devices, UAVs, etc.

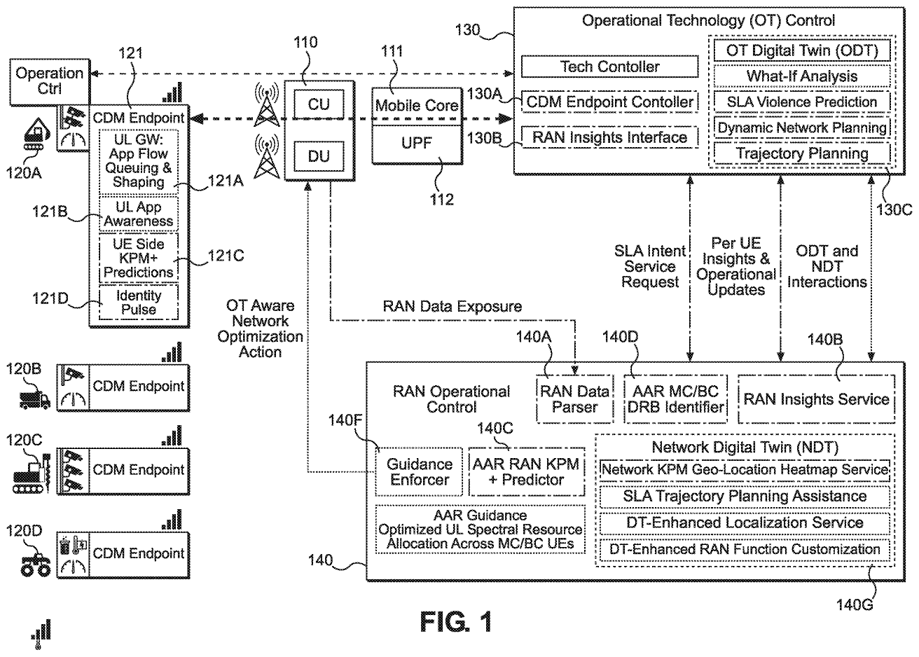

FIG. 1 illustrates an example wireless system according to at least one example embodiment. As shown in FIG. 1, a wireless communication system may include a radio access network (RAN) node 110, at least one wirelessly controlled device (e.g., WCD, a user equipment (UE) device or UE, OT machinery, etc.) 120A to 120D, an OT control network node 130, and/or a RAN operational control network node 140, etc., but the example embodiments are not limited thereto, and for example, may include a greater or lesser number of constituent elements. For example, the wireless communication system may include two or more RAN nodes, three or less WCDs, five or more WCDs, additional base stations, servers, routers, access points, gateways, etc.

The RAN node 110 and the WCD 120A to 120D may be connected over at least one wireless network, such as a cellular wireless access network (e.g., a 3G wireless access network, a 4G-Long Term Evolution (LTE) network, a 5G-New Radio (e.g., 5G) wireless network, a 6G wireless network, a 7G wireless network, a WiFi network, etc.). The wireless network may include a core network (not shown) and/or a Data Network (not shown). The RAN node 110 may connect to other RAN nodes (not shown), as well as to the core network and/or the Data Network, over a wired and/or wireless network. The Data Network may refer to the Internet, an intranet, a wide area network, etc.

According to some example embodiments, the RAN node 110 may act as a relay node (e.g., an integrated access and backhaul (IAB) node) and may communicate with the WCDs 120A to 120D, etc., in combination with at least one base station (and/or access point (AP), router, etc.) (not shown) of the same or a different radio access technology (e.g., WiFi, etc.). According to other example embodiments, the wireless communication system may further include at least one OT control network node 130 and at least one RAN operational control node 140, and data may be transmitted between one or more of the WCDs 120A to 120D, the RAN operational control network node 140, and/or the OT control network node 130, etc., via the RAN node 110, but the example embodiments are not limited thereto.

According to some example embodiments, the OT control network node 130 may be a controller, a network controller, an OT controller, the cloud controller, etc., of one or more of the WCD 120A to 120D, and in example embodiments where there are a plurality of WCDs 120A to 120D, a single OT control network node 130 may control a single WCD, two or more WCDs, all of the WCDs, etc., and/or the control of the plurality of WCDs 120A to 120D may be split among a plurality of OT control network nodes 130, but the example embodiments are not limited thereto.

For example, the OT control network node 130 may control mission and/or business logic of operations of one or more of the WCD 120A to 120D, etc., using one or more applications associated with the specific WCD 120A to 120D, etc. The OT control network node 130 may execute control loops corresponding to the application(s) for one or more of the WCD 120A to 120D based on one or more OT control variables, such as the type of at least one task or operation to be performed by the respective WCD 120A to 120D, the current status of the task to be completed by the respective WCD 120A to 120D, sensor data associated with the respective WCD 120A to 120D, the current location and/or predicted future locations of the respective WCD 120A to 120D, the current and/or predicted future movement speed of the respective WCD 120A to 120D, the amount of data to be uploaded by the respective WCD 120A to 120D, current and/or predicted future network conditions of at least one UL wireless communication channel associated with the respective WCD 120A to 120D, the SLA associated with the at least one UL wireless communication channel associated with the respective WCD 120A to 120D and/or the SLA associated with the task being performed by the respective WCD 120A to 120D, etc., but the example embodiments are not limited thereto. The time period for the execution of the control loop may range from 10 ms to several minutes, but the example embodiments are not limited thereto, and according to some example embodiments, the OT control network node 130 may dynamically change and/or adjust the OT operational control (e.g., instructions, commands, etc.) based on one or more of the OT control variables, etc.

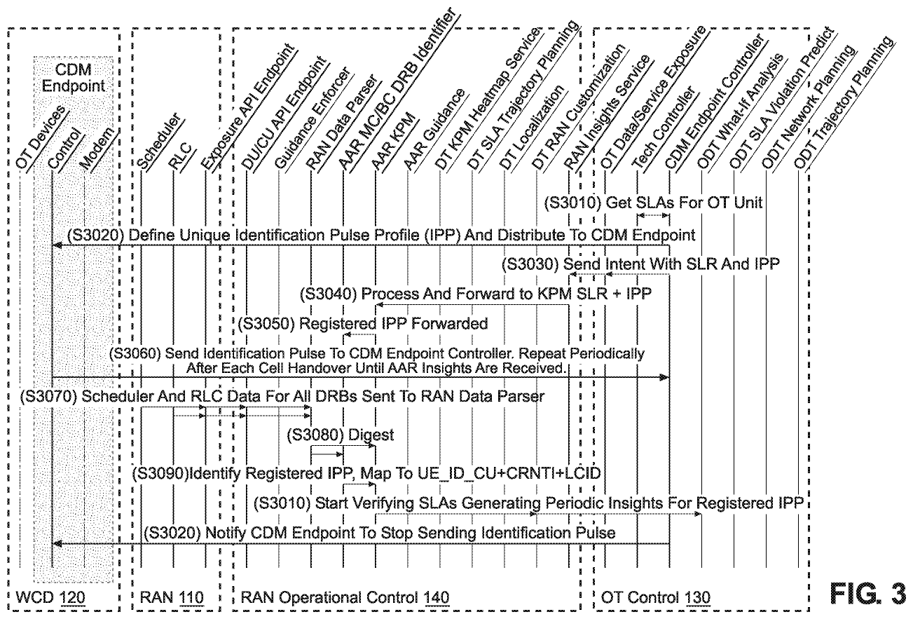

For example, a cognitive digital mine (CDM) endpoint controller 130A may be included in the OT control network node 130 may directly and/or indirectly control operations of functions hosted by a CDM endpoint 121 installed on, for example, WCD 120A, but is not limited thereto. The CDM endpoint controller 130A may also handle a communication protocol between the CDM endpoint 121 by, for example, assigning a unique identifier for communications from the CDM endpoint 121 and/or WCD 120A. For example, the CDM endpoint controller 130A may define at least one unique identification pulse profile (IPP) to identify data traffic originating from the CDM endpoint 121 and/or WCD 120A over a desired and/or specific wireless communication channel assigned to one or more control applications of the WCD 120A, such as at least one Data Radio Bearer (DRB) assigned to the one or more control applications, but the example embodiments are not limited thereto. According to at least one example embodiment, the IPP may be a unique data burst transmission pattern (e.g., a desired data burst sequence, etc.) over a desired time interval, such as transmitting desired amounts of data over a plurality of subintervals of the desired time interval. For example, an IPP assigned to a first DRB for a first control application of the WCD 120A may include a unique data burst pattern of transmitting 1 MB of data over a first subinterval of 10 ms, transmitting 0 MB of data over a second subinterval of 10 ms, and transmitting 2 MB of data over a third subinterval of 10 ms, etc., but the example embodiments are not limited thereto. The IPP assigned for each wireless communication channel may be registered with the RAN operational control network node 140 and allows the RAN operational control network node 140 to determine which wireless communication channel has been assigned to which control application of the WCD 120A, and process the data packets transmitted on the wireless communication channel using the proper SLA requirements, etc. The IPP will be discussed in greater detail in connection with FIG. 3 below.

Additionally, or alternatively, according to some example embodiments, data traffic associated with a particular control application and WCD combination may be identified by other methods, such as using a unique identifier included in a header and/or metadata of the data packets for identification purposes, etc., but are not limited thereto.

Further, the CDM endpoint controller 130A may act as dispatcher and/or intermediary in communications between the OT functions (e.g., OT applications, control applications, etc.) and/or one or more network functions of the core network with the CDM endpoint 121, etc. The CDM endpoint controller 130A may also receive sensor data and/or telemetry data, WCD-measured network performance information (e.g., UL channel quality information, current network resource allocation information, downlink (DL) channel quality measurement information, UL queuing latency information, etc.), location information (e.g., GPS coordinates, altimeter coordinates, etc.) of the WCD 120A, and may distribute the data to other OT control functions, such as the RAN insight interface 130B, the OT digital twin 130C, etc., the RAN operational control network node 140, and/or other network functions, but is not limited thereto. The RAN insight interface 130B, the OT digital twin 130C, and the CDM endpoint controller 130A will be discussed in further detail in connection with FIGS. 3 to 6.

Additionally, the CDM endpoint controller 130A may receive information related to the network from the RAN operational control network node 140, such as network performance information associated with one or more wireless communication channels, such as UL cell congestion information, UL network device channel metric information, UL latency information, UL throughput information, etc., but is not limited thereto. The CDM endpoint controller 130A may further perform dynamic network planning based on one or more of the inputs, such as providing network recommendations regarding the relocation of mobile cell unit(s), the relocation of WCDs, changes in coverage provision by, e.g., drone-based RAN nodes, etc., based on the current network usage and/or predicted future network usage by the WCDs under the control of the CDM endpoint controller 130A, but the example embodiments are not limited thereto.

According to some example embodiments, the WCD 120A to 120D may be wirelessly controlled devices, such as, but not limited to, Internet of Things (IoT) devices, sensors (e.g., thermometers, humidity sensors, pressure sensors, motion sensors, accelerometers, etc.), actuators, robotic devices, drones, connected medical devices, eHealth devices, smart city related devices, security cameras, autonomous devices (e.g., autonomous vehicles, autonomous mining drills, etc.), and/or any other type of stationary or portable device capable of operating according to, for example, the 5G NR communication standard, and/or other wireless communication standard(s).

Additionally, in some example embodiments, the wireless network may further include additional UE devices, such as a smartphone, a tablet, a desktop computer, a laptop computer, a wearable device, etc., but the example embodiments are not limited thereto. The WCD 120A to 120D may be configurable to transmit and/or receive data in accordance to strict latency, reliability, and/or accuracy requirements, such as URLLC communications, TSC communications, etc., but is not limited thereto.

The WCD 120A to 120D may have a CDM endpoint 121 installed and/or included, and/or may include processing circuitry and/or memory for performing operational control, commands, instructions received from a tech controller included in the OT control network node 130 and/or may operate autonomously, but the example embodiments are not limited thereto. The CDM endpoint 121 may include a UL gateway 121A, a UL application awareness service 121B, a UE side key performance metrics (KPM) predictor service 121C, and/or an identity pulse service 121D, etc., but is not limited thereto. The UL gateway 121A may provide connectivity to the wireless network (e.g., RAN node 110, etc.) for the WCD, and may include local wired and/or wireless connections to equipment and/or sensors installed on the WCD, such as video cameras, etc., which may measure and/or provide OT telemetry data for use by the relevant OT control application, etc. The identity pulse service 121D of the CDM endpoint 121 may further be used to uniquely identify data traffic corresponding to a particular control application UL flow by using an IPP received from and/or assigned by the CDM endpoint controller 130A, by transmitting a unique data burst transmission pattern in accordance with the IPP assigned to at least one wireless communication channel (e.g., at least one DRB, etc.) used for the control application UL flow. The UE side KPM predictor service 121C may monitor, measure, and/or compute UE side KPMs, such as network resource allocation information (e.g., the current physical resource block (PRB) allocation, etc.), DL channel quality measurements, UL queuing latency, etc., but is not limited thereto. The UE side KPM predictor service 121C may further generate UE side KPM predictions corresponding to a desired future time period corresponding to predicted future location information of the WCD based on the current location information and network information, and may provide the KPM predictions to the RAN operational control network node 140 and/or the OT control network node 130, etc., via signaling messaging, etc.

The wireless communication system further includes a plurality of transmission/reception points (TRPs) (e.g., a base station, a wireless access point, etc.), such as RAN node 110, etc. The RAN node 110 may operate according to an underlying cellular and/or wireless radio access technology (RAT), such as 5G NR, LTE, Wi-Fi, etc, and may provide wireless network services to one or more WCDs devices and/or other UE devices within one or more cells (e.g., cell service areas, broadcast areas, serving areas, coverage areas, etc.) surrounding the respective physical location of the RAN node. For example, the RAN node 110 may be a node B (NodeB or NB), an evolved NodeB (eNodeB or eNB), a next generation node B (gNB), a Remote Radio Unit (RRU), a remote radio head (RRH), a relay, an Integrated Access and Backhaul (IAB) node, a low power node. The RAN node 110 may be deployed in non-terrestrial network (NTN) devices, such as satellites (e.g., low earth orbit (LEO) satellites or geosynchronous earth orbit (GEO) satellites), aircrafts, or drones, where such NTN devices form a non-terrestrial network such as a ground station, or the RAN node 110 may also be deployed on the group in which case the RAN nodes may be referred to as terrestrial network device. A RAN node 110 comprising terrestrial network devices is generally referred to as a terrestrial network.

The RAN node 110 may have a split architecture where functions of the RAN node (e.g., an eNB or a gNB) are split between various entities. The RAN node 110 that has a split architecture may comprise a radio unit (RU) (otherwise referred to as a remoter radio read (RRH), a centralized unit (CU) and one or more distributed units (DUs). A DU may be connected to a RU via a fronthaul. A DU may be connected to a CU via a midhaul or F1 interface. A CU may be connected to a core network via a backhaul. In some example embodiments, the RAN node 110 may have a split architecture, wherein operations of the RAN node may be carried out by the CU or the DU. For example, one CU may control one or more Dus, but the example embodiments are not limited thereto.

A RU converts radio signals sent to and from an antenna into a digital signal for transmission over packet network, handles the digital front end (DFE) and the lower PHY layer, and includes digital beamforming functionality. A DU is a logical entity (e.g., software) that is hosted and run on a server located near an RU. A CU is a logical entity (e.g., software) that is hosted and run on a server. The CU may be hosted and run on its own server or may be hosted and run on the same server that hosts and runs the DU. located near an RU. The DU includes a subset of the functions of a RAN node (e.g., eNB or gNB, etc.) depending on the split of functions and the CU includes the other functions of a RAN node that are not in the subset of functions of the DU. A DU may comprise a subset of the layers of a protocol stack of a RAN node and a CU may comprise the other layers of the protocol stack that are not in the subset of layers in the DU. For example, in some implementations, a DU may include a radio link control (RLC) layer, a medium access control (MAC) layer and a physical (PHY) layer of a protocol stack for a RAN node, whereas a CU may comprise the layers of the protocol stack of a RAN node above the RLC layer, such as a packet data convergence protocol (PDCP) layer, a radio resource control (RRC) layer and an internet protocol (IP) layer. The operations of a DU are controlled by a CU.

Additionally, the RAN node 110 may be configured to operate in a multi-user (MU) multiple input multiple out (MIMO) mode and/or a massive MIMO (mMIMO) mode, wherein the RAN node 110 transmits a plurality of beams (e.g., radio channels, datastreams, streams, etc.) in different spatial domains and/or frequency domains using a plurality of antennas (e.g., antenna panels, antenna elements, an antenna array, etc.) and beamforming and/or beamsteering techniques. For example, RAN node 110 may transmit and/or receive transmissions using two or more beams, but the example embodiments are not limited thereto, and for example, the RAN node may transmit using a greater or lesser number of beams, etc.

Additionally, WCD 120A to 120D may be located within a cell service area corresponding to the RAN node 110, and may connect to, receive broadcast messages from, receive paging messages from, receive/transmit signaling messages from/to, and/or access the wireless network through, etc., from the RAN node 110. However, the example embodiments are not limited thereto, and for example, one or more of the WCDs 120A to 120D may connect to two or more RAN nodes and may perform carrier aggregation using one or more component carriers (CCs) from one or more of the RAN nodes, etc.

According to at least one example embodiment, the WCD 120A to 120D may include multiple antenna panels (e.g., may be a multi-panel UE device, etc.), and may transmit and/or receive to a plurality of RAN nodes (e.g., TRPs), etc., using the same time-frequency resources and/or using resources overlapping in time, but the example embodiments are not limited thereto.

According to at least one example embodiment, the RAN node 110 may be connected to at least one core network element (e.g., core network elements 111 and/or core network element 112) residing on the core network, such as a core network device, a core network server, access points, switches, routers, nodes, etc., but the example embodiments are not limited thereto. The core network may be implemented as a mobile core 111, and may provide one or more network functions, a user plane function (UPF) 112, and/or other network functions which have not been shown for the sake of clarity, such as an access and mobility management function (AMF), a session management function (SMF), a policy control function (PCF), a unified data management (UDM), an authentication server function (AUSF), an application function (AF), and/or a network slice selection function (NSSF), etc., and/or equivalent functions, but the example embodiments are not limited thereto.

Additionally, according to some example embodiments, a RAN operational control network node 140 may provide operational control of the wireless network and/or the RAN node 110 based on predictions related to network conditions and/or network workload received from the RAN node 110 and/or the WCDs 120A to 120D, and/or predications related to the operation of the WCDs 120A to 120D received from the OT control network node 130 and/or the WCDs 120A to 120D, etc. For example, the RAN operational control network node 140 may include one or more of a RAN data parser 140A, an application aware RAN (AAR) insight service 140B (e.g., AAR insight interface, etc.), an AAR RAN KPM predictor 140C, an AAR MC/BC DRB identifier service 140D, an AAR Guidance service 140E, an AAR guidance enforcer service 140F, and/or a network digital twin 140G, etc., but is not limited thereto.

The RAN data parser 140A may receive data exposed from the CU/DU of the RAN node 110, such as wireless communication channel resource scheduler information (e.g., DRB scheduler information), radio link control (RLC) information, etc., as well as data for specific OT control applications transmitted over the designated wireless communication channel assigned to the OT control applications. The AAR insight service 140B may receive registration information for MC and/or BC applications from the OT control network node 130 and/or CDM endpoint 121, receive updates from the from the OT control network node 130 and/or CDM endpoint 121 after RAN mobility events cause changes in a Quality of Service (QoS) traffic profile to occur, etc. The AAR insight service 140B may also generate and provide network-side KPMs, SLA compliance information (e.g., SLA violation probability information, SLA violation notifications, etc.), and/or other QoS traffic pattern and/or QoS information, that may be used by the OT control network node 130 and/or CDM endpoint 121, etc. The AAR insight service 140B may also receive the IPP registration information which enables the RAN operational control network node 140 to identify, index, and/or filter for data packets transmitted over a wireless communication channel (e.g., DRB, etc.) for a desired OT control application, etc. The IPP registration information may include SLA information (e.g., a SLA profile, SLA requirements, etc.) for the wireless communication channel, etc., which may be used by the RAN operational control network node 140 to enforce and/or comply with the SLA requirements for the associated CDM endpoint 121 data traffic (e.g., MC data traffic, BC data traffic, and/or non-MC data traffic, etc.), by adjusting priority for the different types of data traffic based on the SLA requirements, adjusting network resources allocated to the CDM endpoint 121 for the MC data traffic and/or BC data traffic, etc.

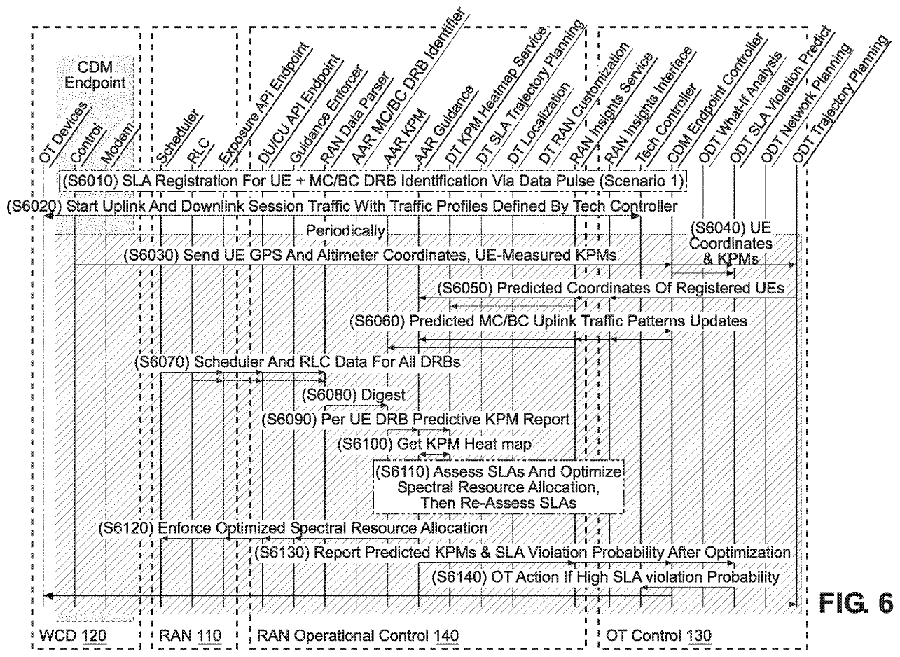

The AAR KPM predictor 140C may monitor and/or predict network-side performance information (e.g., network-side KPMs), such as UL cell congestion information, UL network device channel metric information, UL latency information, UL throughput information, etc., of the wireless communication channel(s) carrying MC/BC data traffic, and may monitor and/or predict SLA information (e.g., SLA violations, the probability of a SLA violation, etc.), etc., and may provide such data to the OT control network node 130, etc. The prediction of SLA violations will be discussed in greater detail in connection with FIG. 6.

The AAR MC/BC DRB identifier service 140D may identify the wireless communication channel carrying MC/BC data traffic based on the IIP of the wireless communication channel, and may map identifiers for the insight services to the RAN identifiers, such as cell radio network temporary identifier (CRNTI), a UE_ID_CU identifier, and/or logical channel ID (LCID) identifier, etc., but is not limited thereto. Accordingly, data traffic for registered OT control applications may be properly identified by the RAN Control 140 even if the IP address associated with the WCD changes due to, for example, network address translation (NAT) performed by the UPF 112, etc.

The AAR Guidance service 140E may adjust, improve, and/or optimize network resource allocations to the wireless communication channel(s) (e.g., the DRBs, etc.) carrying MC/BC application traffic based on the registered SLA profiles associated with each MC and/or BC application. For example, the AAR Guidance service 140E may dynamically adjust network resource allocations and/or scheduling for the relevant wireless communication channel based on the SLA requirements and current network conditions and predicted future network conditions, etc.

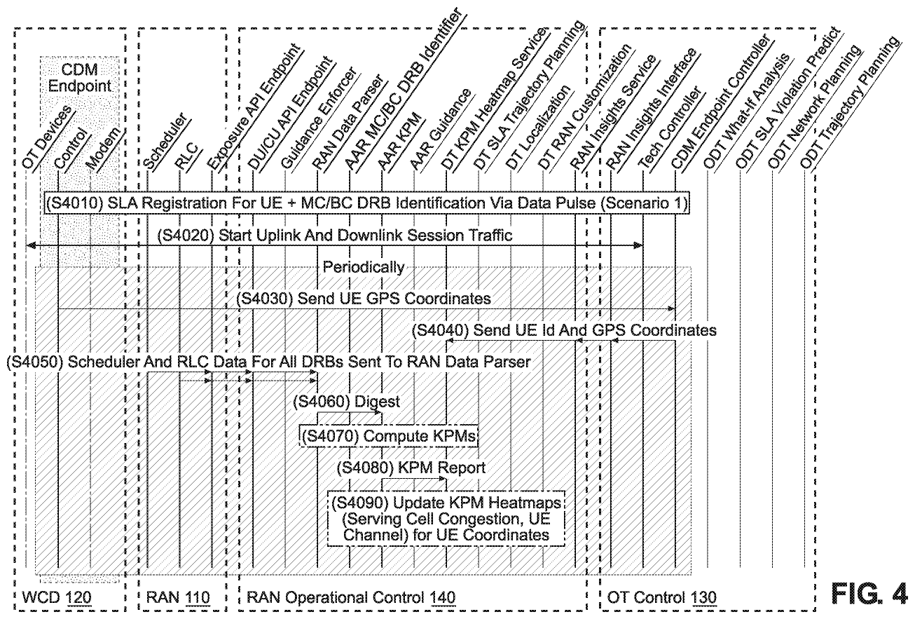

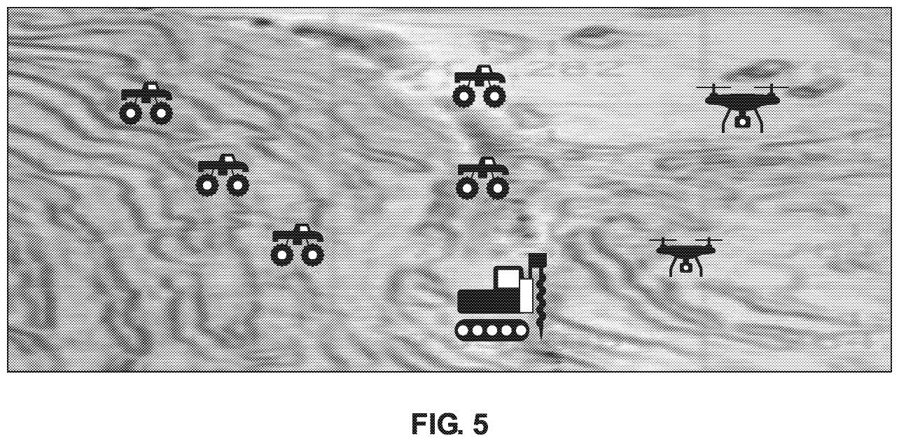

The network digital twin 140G may generate a dynamic network map, such as a geo-location-based KPM heatmap, which may include and/or indicate network condition information and/or network performance information (e.g., serving cell channel quality, cell congestion, throughput, latency, etc.) corresponding to a geographic area served by the RAN node 110 and/or the wireless network, etc., wherein the network condition and/or network performance information may be collected from the WCDs 120A to 120D located within the geographic area and averaged over a desired sliding time window. The network condition and/or network performance information may also be collected/computed by AAR RAN KPM predictor 140C from CU/DU data for the WCDs located in the area. Additionally, while the dynamic network map is discussed herein (and illustrated in FIG. 5) as a visual map, the example embodiments are not limited thereto, and for example, the corresponding KPM information correlated to geographic locations may be stored as data in a table, a database, etc. The dynamic network map will be discussed in greater detail in connection with FIGS. 4 to 5.

The network digital twin 140G may also perform SLA aware trajectory planning assistance for the OT control network node 130 and/or the OT digital twin 130C, and more specifically, generating a prediction map of SLA-assurance which displays SLA violation probability information correlated to geographic locations along the predicted and/or future trajectory and/or path of travel for a future time period for each of the WCDs 120A to 120D, and may generate recommendations and/or instructions for the WCDs 120A to 120D regarding alternate paths and/or adjustment of the current path to avoid detrimental network conditions, etc. Further, the network digital twin 140G may display the current location and the future trajectory of the WCDs on the dynamic network map, but the example embodiments are not limited thereto. The network digital twin 140G may also perform enhanced localization service and provide network-assisted positioning service of the WCDs 120A to 120D to complement the location information provided by the WCDs 120A to 120D, etc. The network digital twin 140G may also perform RAN function customization such as enhancing RAN functions and/or customizing RAN functions to a specific cell environment based on WCD-derived data, such as CSI compression and/or channel estimation functions, etc.

The AAR guidance enforcer service 140F may provide a communication endpoint for enforcing DU/CU radio resource allocation changes, adjustments, and/or optimization, including proactive handover configuration for one or more of the WCDs 120A to 120D based on the dynamic network maps, location information of the WCDs 120A to 120D, etc. The proactive handover configuration may be beneficial in circumstances such as when a wirelessly controlled truck is turning around a corner and may be blocked by another truck traveling towards it in an opposite lane, etc.

According to some example embodiments, the RAN operational control network node 140 may be co-located with the RAN node 110, but is not limited thereto. For example, in other example embodiments, the RAN operational control network node 140 may be hosted within an Open Radio Access Network (O-RAN) defined RAN intelligent controller (RIC) and service management and orchestration (SMO) platform, such as a near-real time RIC and/or a non-real time RIC, etc., a virtual RAN network node, a cloud RAN network node, a virtual RAN cloud network node, etc., but is not limited thereto. As another example, the RAN operational control network node 140 may be implemented within a plurality of network nodes, such as a near-real time RIC and a non-real time RIC, wherein the services of the RAN operational control network node 140 are split between the near-real time RIC (e.g., the RAN data parser 140A, AAR Guidance service 140E, AAR guidance enforcer service 140F, AAR RAN KPM predictor 140C, etc.) and the non-real time RIC (e.g., the AAR MC/BC DRB identifier service 140D, AAR insight service 140B, network digital twin 140G, etc.), but is not limited thereto. Further, the non-real-time RIC may communicate with CU/DU of the RAN node 110 over an O1 interface for RAN data exposure and control, the near-real-time RIC may communicate with CU/DU of the RAN node 110 over an E2 interface for data exposure and control, and the near-real time RIC and the non-real time RIC may communicate over an interface, such as an O-RAN A1 interface, etc., but the example embodiments are not limited thereto. In at least one example embodiment, the RAN Insight Interface 140B may be an O-RAN defined Service Management and Orchestration (SMO) Data and/or Services Exposure Function.

While certain components of a wireless communication network are shown as part of the wireless communication system of FIG. 1, the example embodiments are not limited thereto, and the wireless communication network may include components other than that shown in FIG. 1, which are desired, necessary, and/or beneficial for operation of the underlying networks within the wireless communication system, such as access points, switches, routers, nodes, servers, gateways, etc.

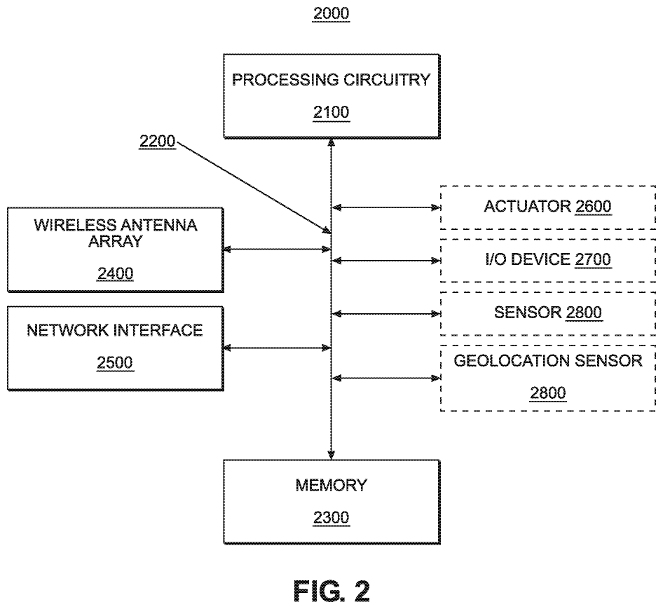

FIG. 2 illustrates a block diagram of an example network device and/or network node according to at least one example embodiment. The network device of FIG. 2 may correspond to a network node, such as the RAN node 110, the OT control network node 130, and/or the RAN operational control network node 140, etc., and/or a network device corresponding to one or more of the WCDs 120A to 120D of FIG. 1, but the example embodiments are not limited thereto.

Referring to FIG. 2, a network device 2000 (e.g., a network node, etc.) may include processing circuitry, such as processing circuitry 2100, at least one communication bus 2200, a memory 2300, at least one wireless antenna array 2400, and/or at least one network interface 2500 (e.g., a private network interface, a core network interface, etc.), etc., but the example embodiments are not limited thereto. For example, the network interface 2500 and the wireless antenna array 2400 may be combined into a single network interface, etc., or the network device 2000 may include a plurality of wireless antenna arrays, a plurality of network interfaces, etc., and/or any combinations thereof. The memory 2300 may include various special purpose program code including computer executable instructions for performing the operations of FIGS. 3 to 6, etc., which may cause the network device 2000 to perform the one or more of the methods of the example embodiments, but the example embodiments are not limited thereto.

In at least one example embodiment, the processing circuitry 2100 may include at least one processor (and/or processor cores, distributed processors, networked processors, application processors, etc.), which may be configured to control one or more elements of the network device 2000, and thereby cause the network device 2000 to perform various operations. The processing circuitry 2100 is configured to execute processes by retrieving special purpose program code (e.g., special purpose computer readable instructions) corresponding to one or more operations of one or more methods described herein and data from the memory 2300 to process them, thereby executing special purpose control and functions of the entire network device 2000. Once the special purpose program instructions are loaded into the processing circuitry 2100, the processing circuitry 2100 executes the special purpose program instructions, thereby transforming the processing circuitry 2100 into a special purpose processor. According to some example embodiments, the processing circuitry 2100 may include a specially programmed FPGA, a special purpose system-on-chip (SoC), a special purpose ASIC, etc., which is specifically provided to perform the functionality related to one or more operations of the methods of FIGS. 3 to 6, etc., but the example embodiments are not limited thereto.

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the network device 2000, such as the methods discussed in connection with FIGS. 3 to 6, the at least one network interface 2500, the at least one wireless antenna array 2400, etc. Such software elements may be loaded from a non-transitory computer-readable storage medium independent of the memory 2300, using a drive mechanism (not shown) connected to the network device 2000, or via the at least one network interface 2500, and/or at least one wireless antenna array 2400, etc.

In at least one example embodiment, the communication bus 2200 may enable communication and data transmission to be performed between elements of the network device 2000. The bus 2200 may be implemented using a high-speed serial bus, a parallel bus, and/or any other appropriate communication technology. According to at least one example embodiment, the network device 2000 may include a plurality of communication buses (not shown), such as an address bus, a data bus, etc.

Additionally, according to some example embodiments, the network device 2000 may also operate as a RAN node, for example, a 4G RAN node, a 5G RAN node, a 6G RAN node, a 7G RAN node, a Wi-Fi base station, etc., for any UE devices and/or WCDs within wireless range of the network node, but the example embodiments are not limited thereto. Moreover, the network device 2000 may operate as an OT control network node 130, a RAN operational control network node 140, etc., but the example embodiments are not limited thereto.

According to other example embodiments, the network device 2000 may operate as a WCD (e.g., a robot, an industrial sensor, an AGV, a UAV, etc.) and may further include at least one actuator 2600, at least one input/output (I/O) device 2700 (e.g., a touchscreen, a microphone, a camera, a keyboard, a mouse, a camera, a speaker, etc.), at least one sensor 2800 (proximity sensors (e.g., an infra-red proximity sensor, a radar sensor, a LIDAR sensor, etc.), thermometers, humidity sensors, pressure sensors, motion sensors, accelerometers, cameras, computer vision cameras, etc.), and/or geo-location sensor (e.g., GPS, etc.), but is not limited thereto. According to some example embodiments, the WCD may also include at least one battery (not shown), a display panel, etc., but the example embodiments are not limited thereto.

The network device 2000 may also include at least one network interface 2500, and/or at least one wireless antenna array 2400, etc. The at least one wireless antenna array 2400 may include an associated array of radio units (not shown) and may be used to transmit the wireless signals in accordance with a radio access technology, such as 4G LTE wireless signals, 5G NR wireless signals, RFID wireless signals, Bluetooth wireless signals, WiFi wireless signals, etc., to at least one WCD and/or UE device, such as the WCDs 120A to 120D, etc. According to some example embodiments, the wireless antenna array 2400 may be a single antenna, or may be a plurality of antennas, etc. For example, the wireless antenna array 2400 may be configured as a grid of beams (GoB) which transmits a plurality of beams in different directions, angles, frequencies, and/or with different delays, etc., but the example embodiments are not limited thereto.

The network device 2000 may communicate with a core network (e.g., a backend network, backhaul network, backbone network, a private network, a local area network (LAN), a WAN, Data Network, etc.) via the network interface 2500. The network interface 2500 may be a wired and/or wireless network interface and may enable the network device 2000 to communicate and/or transmit data to and/or from network devices on the backend network, such as neighboring network devices and/or network nodes (not shown), a core network gateway (not shown), a Data Network, such as the Internet, intranets, WANs, LANs, etc.

While FIG. 2 depicts an example embodiment of a network device 2000, the network devices are not limited thereto, and may include additional and/or alternative architectures that may be suitable for the purposes demonstrated.

FIG. 3 is a transmission diagram illustrating an example method for performing service level agreement (SLA) registration according to at least one example embodiment. While FIG. 3 depicts a single RAN node 110, a single WCD 120, a single OT control network node 130, and a single RAN operational control network node 140, the example embodiments are not limited thereto and there may be a plurality of RAN nodes 110, a plurality of WCDs 120, a plurality of OT control network nodes 130, and/or a plurality of RAN operational control network nodes 140, etc.

According to some example embodiments, communications between one or more of the WCDs 120A to 120D to the OT control network node 130 and/or the RAN operational control network node 140 may be transmitted through the RAN node 110 and/or the core network, wherein the UPF 112 may perform a network address translation (NAT) on the IP address associated with the WCDs 120A to 120D, thereby making the IP address of the WCDs 120A to 120D an unsuitable identifier for the WCDs 120A to 120D and/or the data traffic originating from the WCDs 120A to 120D, etc.

Accordingly, it is desired to assign a unique identifier to each OT control application and wireless communication channel combination to allow for data traffic corresponding to each OT control application to be easily identified by the network nodes and for appropriate SLA be applied to such data traffic.

In operation S3010, the OT control network node 130 may obtain SLA information (e.g., the SLA requirements) associated with an OT control application. For example, the OT control application may include at least one BC and/or MC control flows, and accordingly the SLA requirements may differ for the control flows, but the example embodiments are not limited thereto. In operation S3020, the OT control network node 130 may define and/or assign a unique identification pulse profile (IPP) to the OT control application and may transmit the unique IPP to the WCD 120 and/or the CDM endpoint 121. According to some example embodiments, the unique IPP may define a unique data burst transmission pattern for transmitting UL data from the WCD 120 to the RAN node 110 in a defined unique manner which allows the RAN node 110 and/or the RAN operational control network node 140 to identify data packets associated with the OT control application and apply the relevant SLA information. According to at least one example embodiment, the IPP may specify a transmission time window of a desired length (e.g., 50 ms, etc.), specify subinterval transmission periods of desired lengths (e.g., 10 ms, etc.), and the desired amount of data to transmit within each subinterval, but is not limited thereto. For example, a first IPP may uniquely define that the WCD 120 transmit 1 MB of data during a first subinterval, 0 MB of data during a second subinterval, and 2 MB of data during a third subinterval, on a first wireless communication channel associated with a first OT control application, but the example embodiments are not limited thereto. A second IPP may be uniquely defined for the WCD 120 for use on a second wireless communication channel associated with a second OT control application, such as transmitting 5 MB of data during the first subinterval, 5 MB of data during the second subinterval, and 0 MB of data during the third subinterval, thereby allowing the RAN node 110 and/or the RAN operational control network node 140 to determine that data received on the first wireless communication channel corresponds to the first OT control application and data received on the second wireless communication channel corresponds to the second OT control application, based on the transmission patterns of an identification pulse sent by the WCD 120.

The WCD 120 and/or the CDM endpoint 121 may register and/or associate the IPP with the wireless communication channel (e.g., DRB, etc.) being used to transmit/receive data related to the OT control application as well as the SLA information related to the OT control application and the wireless communication channel associated with the OT control application, but the example embodiments are not limited thereto. In operation S3030, the OT control network node 130 may register the IPP and the SLA information associated with the OT control application and the associated wireless communication channel with the RAN operational control network node 140 (e.g., the RAN insight service, etc.), and in operations S3040 and S3050, the OP control network node 130 may forward and/or make available the IPP and SLA information to the AAR KPM and/or the AAR MC/BC DRB identifier, etc.

In operation S3060, the WCD 120 may transmit at least one identification pulse to the OT control network node 130 and/or the RAN operational control network node 140 via the RAN node 110 based on the IPP assigned to the relevant OT application over the wireless communication channel associated with the OT application. The data used for transmitting the identification pulse pattern may be the application data that is queued in the uplink gateway, or new data specifically injected and/or transmitted by the WCD 120 for the purpose of transmitting the identification pulse. The WCD 120 may periodically repeat the identification pulse transmission until a notification is received to discontinue transmission of the identification pulse from the OT control network node 130. Additionally, the WCD 120 may re-start transmission of the identification pulse after a cell handover has occurred, but is not limited thereto.

In operation S3070, the RAN node 110 may identify data packets associated with the registered OT control application based on the identification pulse and the registered IPP associated with the OT control application, and the RAN operational control network node 140 may map the IP address of the WCD 120 to a wireless communication channel identifier, such as at least one of a Cell Radio Network Temporary Identifier (CRNTI) identifier, a temporary UE identifier assigned by CU (UE_ID_CU), and/or a Logical Channel identifier (LCID), etc., but the example embodiments are not limited thereto. The identification is performed not based upon reading contents of the data (which is typically encrypted), but based upon the idle-burst pattern of the data transmission defined by the IPP. In operation S3080, the RAN operational control network node 140 may filter for and forward the wireless communication channel resource scheduler information (e.g., DRB scheduler information), radio link control (RLC) information, and/or data associated with the registered OT control application to the RAN data parser. In operation S3080, the RAN data parser may forward the data to the AAR MC/BC DRB identifier and/or the AAR KPM service of the RAN operation control network node 140, but is not limited thereto. In operation S3090, the AAR MC/BC DRB identifier may use the received data to verify that the data for the wireless communication channel matches the previously registered IPP, and if a match is found, the AAR MC/BC DRB identifier notifies the AAR KPM of the wireless communication channel identifier (e.g., a tuple of CRNTI identifier, a UE_ID_CU identifier, and/or a LCID identifier, etc.) matching the IPP.

In operation S3100, the AAR KPM service of the RAN operational control network node 140 may perform KPM computation on the matched wireless communication channel and verify the SLA requirements associated with the matched wireless communication channel, etc. The RAN operational control network node 140 may then transmit a network insight digest message to the OT control network node 130 for the registered IPP, and in operation S3110, the OT control network node 130 may transmit the notification message to the WCD 120 and/or CDM endpoint 121, to discontinue transmission of the identification pulse.

FIG. 4 is a transmission diagram illustrating an example method for generating a network map according to at least one example embodiment. FIG. 5 illustrates an example network map according to at least one example embodiment.

In operation S4010, an SLA registration for the WCD 120 and/or MC/BC OT control application identification procedure may be performed in accordance with FIG. 3, but the example embodiments are not limited thereto. In operation S4020, the OT control network node 130 and the WCD 120 may engage in a communication session (e.g., UL and DL) using a wireless communication channel via the RAN node 110, etc., but the example embodiments are not limited thereto. For example, the OT control network node 130 may define bitrate resolutions and/or view angle widths of video cameras, LiDAR resolution, and/or data sensor report frequencies and/or volumes, etc., but is not limited thereto. In operation S4030, the WCD 120 may periodically send its current location information (e.g., GPS coordinates, etc.) to the OT control network node 130 at desired time intervals. In operation S4040, the OT control network node 130 may transmit an identifier for the WCD 120 (e.g., a UE ID, etc.) and the current location information to the RAN operational control network node 140. In operation S4050, the RAN node 110 may transmit the scheduling information and/or RLC data for all wireless communication channels (e.g., all DRBs) to the RAN operational control network node 140. In operation S4060, the RAN operational control network node 140 may parse the scheduling information and/or RLC data for data associated with each wireless communication channel. In operation S4070, the RAN operational control network node 140 may compute the network performance information (e.g., network-side KPMs) for each wireless communication channel. In operation S480, the network performance information may be forwarded to the network digital twin 140G, and in operation S490, the RAN operational control network node 140 and/or network digital twin 140G may generate and/or update the dynamic network map based on the network performance information.

Referring now to FIG. 5, the dynamic network map may correspond to a geographic territory associated with the wireless network (e.g., the serving area of the RAN node 110, etc.). The geographic territory may be divided into a plurality of geographic pixels (e.g., units of geographic areas represented on the network map) wherein each geographic pixel is a three-dimensional (3D) cube with, e.g., an X-axis side representing a latitude coordinate, a Y-axis side representing a longitudinal coordinate, and a Z-axis side representing an altitude, but the example embodiments are not limited thereto. The size of each pixel (and/or the length of each side of the pixel) may be selected based upon the sensitivity of the available location sensors (e.g., GPS positioning sensor and altimeter used by the WCD 120) which mapped the corresponding geographic area. Each pixel may contain information which indicates the network performance information collected by at least one WCD at the geographic location, and may be averaged over all WCDs which traveled over the geographic location corresponding to the pixel during a desired sliding time window, but the example embodiments are not limited thereto. For example, each pixel may include information regarding at least one of: serving cell congestion information corresponding to the 3D geographic area of the pixel, UL channel performance metric information corresponding to the 3D geographic area of the pixel as measured for the serving cell, and/or probability of the at least one network device being served by a particular serving cell corresponding to the 3D geographic area of the pixel, etc., but is not limited thereto. Each pixel may be color coded to indicate the level of network congestion and/or network condition of the geographic area corresponding to the pixel. Additionally, according to some example embodiments, the current location (or most recent) location of each WCD in the geographic area may be represented on the relevant pixel of the dynamic network map, and a predicted and/or future path or trajectory of travel may be indicated on the dynamic network map, but the example embodiments are not limited thereto. Moreover, the locations of stationary and/or mobile RAN nodes may also be illustrated on the dynamic network map.

FIG. 6 is a transmission diagram illustrating an example method for performing predictive SLA verification and operational control of a network device according to at least one example embodiment.

In operation S6010, an SLA registration for the WCD 120 and/or MC/BC OT control application identification procedure may be performed in accordance with FIG. 3, but the example embodiments are not limited thereto. In operation S620, similar to operation S4020, the OT control network node 130 and the WCD 120 may engage in a communication session (e.g., UL and DL) using a wireless communication channel via the RAN node 110, etc., but the example embodiments are not limited thereto. For example, the OT control network node 130 may define bitrate resolutions and/or view angle widths of video cameras, LiDAR resolution, and/or data sensor report frequencies and/or volumes, etc., but is not limited thereto. In operation S6030, the WCD 120 may transmit its current location information and/or WCD-measured network performance information (e.g., network device-measured KPMs, etc.) to the OT control network node 130 (e.g., the CDM endpoint controller 130A, etc.), but is not limited thereto. In operation S6040, the CDM endpoint controller 130A may forward the received location information and/or network device-measured performance information to the OT digital twin 130C. In operation S6050, the OT digital twin 130C may calculate and/or predict the future location information (e.g., the future path and/or travel trajectory) of the WCD 120 for a future time period. For example, the future location information may include a plurality of geographic coordinates (e.g., a sequence of geographic coordinates) that the WCD 120 is predicted to travel along during the future time period, etc. The OT digital twin 130C may transmit the future location information to the RAN operational control network node 140, and the future location information may be used by the RAN operational control network node 140 for generating and/or updating the dynamic network map as discussed in connection with FIGS. 4 and 5. In operation S6060, the OT digital twin 130C may also predict network (e.g., MC/BC UL data traffic, etc.) traffic pattern information for the future time period based on the OT application operational control settings assigned to and/or defined for the WCD 120, such as the bitrate resolutions and/or view angle widths of video cameras, a LiDAR resolution setting, and/or data sensor report frequencies and/or volumes, etc., and may transmit the predicted network traffic pattern information to the RAN operational control network node 140, e.g., the network digital twin 140G.

In operation S6070, the RAN node 110 may forward the scheduling information and/or RLC data for all wireless communication channels to the RAN operational control network node 140. In operation S6080, the RAN data parser 140A of the RAN operational control network node 140 may generate at least one digest using the received scheduling information and/or RLC data for each of the wireless communication channels, etc. In operation S6090, the AAR RAN KPM predictor 140C may monitor and predict the RAN network performance information (e.g., the network-side KPMs, the RAN KPMs, etc.) for a future time period. The network performance information may include at least one of: UL cell congestion, UL UE channel metrics, UL latency, etc., but is not limited thereto. According to at least one example embodiment, the UL cell congestion metric may be calculated and/or computed to indicate a number of UL PRBs that are available to an ideal “very active” wireless flow and/or data radio bearer (e.g., DRB) that continuously has data to transmit in the uplink direction during each time period. In another example embodiment, the UE channel metric may be calculated and/or computed to indicate an average number of bytes per PRB that the uplink scheduler may pack using at least one selected modulation and coding scheme (MCS). In another example embodiment, the UE channel metric may be derived from the Sounding Reference Signal (SRS) exposed by the DU. In another example embodiment, the AAR RAN KPM predictor 140C may predict the UL throughput for the WCD (e.g., the UE, etc.) using the above congestion and/or channel metrics, etc., but is not limited thereto. In another example embodiment, the AAR RAN KPM predictor 140C may predict an uplink latency from uplink throughput and the RLC data. The AAR RAN KPM predictor 140C may send the predicted KPMs for each MC/BC wireless communication channel to the AAR Guidance service 140E and/or the network digital twin 140G, etc.

In operation S6100, the network digital twin 140G of the RAN operational control network node 140 may generate and/or update the dynamic network map using the predicted KPMs and/or the current and/or future location information in accordance with FIGS. 4 to 5, but is not limited thereto.

In operation S6110, the RAN operational control network node 140 (and/or the AAR Guidance service 140E) may determine SLA compliance information based on the information contained in the dynamic network map and/or the current and/or predicted network-side KPMs, but is not limited thereto. More specifically, the RAN operational control network node 140 may determine whether an OT application-wireless communication channel combination will violate its SLA requirement based on the registered SLA information associated with the OT application-wireless communication channel combination and a SLA compliance threshold. The SLA compliance threshold may be set and/or configured based on an acceptable amount of SLA violations before adjustment of the network resource allocation for the relevant WCD is required, and may be based on, e.g., the terms of the SLA and/or the priority level of the OT application, but the example embodiments are not limited thereto.

If the RAN operational control network node 140 determines that the SLA compliance threshold is exceeded, the RAN operational control network node 140 may determine and/or adjust the network resource allocation for the wireless communication channel associated with the relevant WCD and OT application such that the SLA violation is reduced and/or corrected, if possible. The RAN operational control network node 140 may further predict the network-side KPMs and/or predict the SLA information for the future time period based on the adjusted network resource allocation. More specifically, the predicted SLA information may include predictions regarding the probability of SLA violations during the future time period based on the adjusted network resource allocation and the predicted network performance information associated with the future locations (e.g., the predicted travel path) of the relevant WCD, etc.

In operation S6120, the RAN operational control network node 140 may transmit the adjusted and/or modified network resource allocation recommendation to the RAN node 110 for implementation and/or enforcement for the relevant wireless communication channel and the relevant WCD, etc. In at least one example embodiment, the network resource allocation implementation may include dynamic changes to at least one scheduling weight for at least one DRB (e.g., at least one wireless communication channel, etc.). In operation S6130, the RAN operational control network node 140 may transmit the predicted network performance information and the predicted SLA information to the OT control network node 130. In operation S6140, the OT control network node 130 may adjust and/or modify the operation of the relevant WCD for the future time period based on the received predicted network performance information and the predicted SLA information, etc. For example, if the WCD was originally scheduled to travel through a geographic area with poor network connectivity, and the predicted SLA information indicated that there was a high probability of SLA violations even after the adjusted network resource allocation, the OT control network node 130 may adjust the operation of the WCD such that, for example, the WCD avoids the geographic area with poor network connectivity entirely, decreases the amount of time spent in the geographic area, reduces the amount of UL data being transmitted while in the geographic area (e.g., by reducing the resolution of a video data being transmitted, reducing the LiDAR resolution, etc.), thereby improving the operation of the WCD, but the example embodiments are not limited thereto. According to some example embodiments, operations S6030 to S6140 may be periodically repeated at desired time intervals, but the example embodiments are not limited thereto.

Through the descriptions of the preceding implementations, the subject matter disclosed may be implemented by using hardware only, or by using software and a necessary hardware platform, or by a combination of hardware and software. The coding of software for carrying out the above-described methods described is within the scope of a person of ordinary skill in the art having regard to the present disclosure. Based on such understandings, the technical solution of the subject matter disclosed herein may be embodied in the form of a software product. The software product may be stored in a non-volatile or non-transitory storage medium, which may be, for example, an optical storage medium, flash drive, a hard disk, a solid-state drive, a universal serial bus (USB) drive, etc. The software program or product (otherwise referred to as a computer program or computer product) includes instructions that enable a computing device (e.g., a user equipment or a core network apparatus as described herein) to execute the methods provided in the implementations of the present disclosure.

The operations (otherwise referred to as steps) of the methods shown in the flowcharts in the drawings and described herein are for purposes of illustration only. There may be many variations to these operations or steps without departing from the scope of the present disclosure. For instance, the operations may be performed in a differing order, or operations may be added, deleted, or modified, as appropriate.

It is anticipated that features from one or more of the above-described implementations may be selected to create alternate implementations comprised of a sub-combination of features which may not be explicitly described above. In addition, features from one or more of the above-described implementations may be selected and combined to create alternate implementations comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example implementations described herein. It will, however, be understood by those of ordinary skill in the art that the example implementations described herein may be practiced without these specific details. Furthermore, well-known methods, procedures, and elements have not been described in detail so as not to obscure the example implementations described herein. The subject matter described herein and in the recited claims intends to cover and embrace all suitable changes in technology.

Although the subject matter disclosed herein and some of its advantages (e.g., technological improvements) have been described in detail, other advantages (e.g., other technological improvements) may be apparent from the present disclosure. It should be understood that various changes, substitutions and alterations can be made to the subject matter disclosed herein without departing from the scope of the present disclosure as defined by the appended claims.

The subject matter disclosed herein may be embodied or implemented in other specific forms without departing from the scope of the claims. The described example implementations are to be considered in all respects as being only illustrative and not restrictive. The subject matter disclosed herein intends to cover and embrace all suitable changes in technology. The scope of the present disclosure is, therefore, described by the appended claims rather than by the foregoing description. The scope of the claims should not be limited by the implementations set forth in the examples or implementations described herein but should be given the broadest interpretation consistent with the description as a whole.

What is claimed is:

1. A network node comprising:
memory storing computer readable instructions; and
processing circuitry configured to execute the computer readable instructions to cause the network node to,
obtain service level agreement (SLA) information associated with at least one wireless communication channel, location information associated with at least one network device, and network device-measured network performance information associated with the at least one wireless communication channel,
obtain network resource information and network scheduling information associated with the at least one wireless communication channel,
predict network performance information associated with the at least one wireless communication channel for a future time period based on the location information, the network device-measured network performance information, the network resource information, and the network scheduling information,
predict SLA compliance information for the future time period based on the SLA information associated with the at least one wireless communication channel and the predicted network performance information associated with the at least one wireless communication channel, and
adjust network resource allocation for the at least one network device based on the predicted SLA compliance information.

2. The network node of claim 1, wherein the network performance information includes at least one of:
uplink (UL) cell congestion information, UL network device channel metric information, UL latency information, UL throughput information, or any combinations thereof.

3. The network node of claim 2, wherein the network device-measured network performance information includes at least one of:
current network resource allocation information associated with the at least one network device, downlink (DL) channel quality measurement information associated with the at least one network device, UL queuing latency information associated with the at least one network device, or any combinations thereof.

4. The network node of claim 3, wherein the network node is further caused to adjust network resource allocation for the at least one network device by:
adjust network scheduling for the at least one network device for the future time period based on the predicted SLA compliance information; and
transmit the adjusted network resource allocation and the adjusted network scheduling to a radio access network (RAN) node serving the at least one network device.

5. The network node of claim 4, wherein the network node is further caused to:
transmit the predicted network performance information and the predicted SLA compliance information to a network controller of the at least one network device, the transmitting enabling the network controller to,
modify operation of the at least one network device based on the predicted network performance information, the predicted SLA compliance information, and a SLA compliance threshold.

6. The network node of claim 5, wherein the network node is further caused to:
obtain an identification pulse profile (IPP) associated with the at least one wireless communication channel from a network controller of the at least one network device;
register the IPP, the registering including associating the IPP with the at least one network device;
identify the network resource information and the network scheduling information associated with the at least one wireless communication channel from network data received by the network node based on the registered IPP;
predict the network performance information based on the identified network resource information and the identified network scheduling information; and
determine whether a SLA violation has occurred based on the SLA information and the predicted network performance information.

7. The network node of claim 6, wherein the network node is further caused to:
obtain predicted UL communication patterns associated with the at least one network device from the network controller of the at least one network device; and
generate a network map corresponding to a target time period based on the network performance information, the network device-measured network performance information, the location information associated with the at least one network device, and the predicted UL communication patterns associated with the at least one network device.

8. The network node of claim 7, wherein the network map indicates at least one of:
a location of the at least one network device, serving cell congestion information, UL channel performance metric information, probability of the at least one network device being served by a particular serving cell, or any combinations thereof.

9. The network node of claim 8, wherein
the network map further includes a plurality of pixels, each pixel corresponding to a three-dimensional (3D) geographic area;
a size of each pixel of the network map is based on a sensitivity of available location sensors corresponding to the 3D geographic area; and
each pixel includes information indicating at least one of:
serving cell congestion information corresponding to the 3D geographic area, UL channel performance metric information corresponding to the 3D geographic area, probability of the at least one network device being served by a particular serving cell corresponding to the 3D geographic area, or any combinations thereof.

10. The network node of claim 9, wherein the at least one wireless communication channel is at least one RAN Data Radio Bearer configured to carry UL traffic associated with at least one application executed by the at least one network device.

11. The network node of claim 10, wherein the location information associated with at least one network device includes current location information associated with the at least one network device and future location information associated with the at least one network device predicted by a network controller of the at least one network device.

12. The network node of claim 11, wherein the network node is at least one of:
a near-real time radio access network (RAN) intelligent controller (RIC), a non-real time RIC, a virtual RAN, or a cloud RAN, or any combinations thereof.

13. A network node comprising:
memory storing computer readable instructions; and
processing circuitry configured to execute the computer readable instructions to cause the network node to,
obtain current location information and network device-measured network performance information from at least one network device,
predict future location information for the at least one network device for a future time period based on operation control of the at least one network device for the future time period,
predict future uplink (UL) network traffic information associated with at least one wireless communication channel for the future time period based on the predicted future location information and current UL network traffic information associated with the at least one wireless communication channel,
transmit service level agreement (SLA) information associated with the at least one wireless communication channel, the current location information, the predicted future location information, the current UL network traffic information, the predicted future UL network traffic information, and the network device-measured network performance information associated with the at least one wireless communication channel,
obtain predicted SLA compliance information and predicted network performance information associated with the at least one network device from a network control node, and
modify the operation control of the at least one network device for the future time period based on the predicted SLA compliance information and a SLA compliance threshold.

14. The network node of claim 13, wherein the network device-measured network performance information includes at least one of:
current network resource allocation information associated with the at least one wireless communication channel, downlink (DL) channel quality measurement information associated with the at least one network device, UL queuing latency information associated with the at least one network device, or any combinations thereof.

15. The network node of claim 14, wherein the network node is further caused to:
obtain the SLA information associated with the at least one wireless communication channel;
define a plurality of identification pulse profiles (IPP) for a plurality of wireless communication channels, the plurality of wireless communication channels including the at least one wireless communication channel;
transmit the SLA information and the IPP for the at least one wireless communication channel to the network operational control node;
receive the predicted SLA compliance information from the network operational control node in response to the SLA information, the predicted SLA compliance information including at least one predicted SLA violation notification; and
modify the operation control of the at least one network device in response to the at least one predicted SLA violation notification exceeding the SLA compliance threshold.

16. The network node of claim 15, wherein the network node is further caused to:
predict UL communication patterns associated with the at least one network device based on telemetry information associated with the at least one network device and application session status associated with the at least one network device;
transmit the predicted UL communication patterns to the network operational control node; and
transmit the predicted future location information for the at least one network device to the network operational control node, the predicted future location information including a plurality of future location coordinates of the at least one network device, each of the plurality of future location coordinates associated with a future timestamp.

17. The network node of claim 16, wherein the network node is further caused to:
transmit at least one identification pulse profile (IPP) associated with the at least one wireless communication channel to the at least one network device, the IPP uniquely identifying the at least one wireless communication channel;
periodically receive an identification pulse from the at least one network device, the identification pulse corresponding to the IPP; and
transmit a notification to the at least one network device in response to receiving the predicted SLA compliance information from the network operational control node, the notification instructing the at least one network device to discontinue transmission of the identification pulse.

18. The network node of claim 17, wherein the identification pulse is a unique data burst transmission pattern assigned to the at least one wireless communication channel.

19. The network node of claim 18, wherein the network node is further caused to:
periodically receive the current location information and the network device-measured network performance information from the at least one network device;
transmit the received current location information and the network device-measured network performance information to the network operational control node; and
receive the predicted SLA compliance information and the predicted network performance information from the network operational control node in response to the transmission.

20. A network device comprising:
memory storing computer readable instructions; and
processing circuitry configured to execute the computer readable instructions to cause the network device to,
receive at least one identification pulse profile (IPP) associated with at least one wireless communication channel from a network controller associated with the network device, the IPP identifying the at least one wireless communication channel using a unique data burst transmission pattern assigned to the at least one wireless communication channel;
periodically transmit an identification pulse to the network controller, the identification pulse corresponding to the IPP;
periodically transmit current location information and network device-measured network performance information associated with the at least one wireless communication channel to the network controller; and
receive adjusted network resource allocation from a network node and modified operation control instructions from the network controller in response to the transmitted current location information and the transmitted network device-measured network performance information.
